(19) United States
(12) Patent Application Publication
(10) Pub. No.: US 2020/0041230 A1
(43) Pub. Date: Feb. 6, 2020

(54) METHOD OF MAKING AND DEPLOYING A BULLET PROOF VEST

(71) Applicant: GEORGE RAMIREZ, Miami, FL (US)

(72) Inventor: GEORGE RAMIREZ, Miami, FL (US)

(21) Appl. No.: 16/055,916

(22) Filed: Aug. 6, 2018

(51) Int. Cl. F41H 1/02; F41H 5/04; B29C 70/34

(52) U.S. Cl. CPC F41H 1/02; A41D 1/04; B29C 70/34; F41H 5/0485

(57) ABSTRACT

A method of making and deploying a bullet proof vest that can be used to protect students at points of education. The method involves a process of combining/bonding fifteen fiberglass sheets with fiberglass resin in a time specific manner and then pressing the fiberglass sheets together thereby forming a fiberglass plate. A pair of fiberglass plates formed using the present method are thereafter inserted within a vest that has a front and a back receiving pocket. The vest has a strap that is used to tighten the vest on a user wearing the vest. The bullet proof vest of the present invention is inexpensive, lightweight and may also include a tracking device that will inform the authorities of the deployment of the vest. The tracking device of the bullet proof vest will connect to a central monitoring system and will be stored/deployed within an educational desk.

### BACKGROUND

The present invention is directed to a method of making and deploying an inexpensive bullet proof vest that is lightweight and that can be tracked.

The present wave of school shootings inspired the inventor of the present invention to conceive of an alternative to the expensive bullet proof vests that are in the marketplace.

The inventor realized that many of the tragedies that have recently transpired were due to the children not having adequate protection from the massacres.

He believes that if the children were to have a bullet proof vest that would allow them to flee rather than to hide from a school shooter, that some of the students would increase their chances of survival.

After researching the art of bullet proof vests, he realized that the keys to having a bullet proof vest placed in each school district would come down to the price of each vest, the weight of each vest, and the tracking of each vest.

If the cost to deliver the bullet proof vest to the schools is cost prohibitive, then school districts would not favor distributing the vests to their students.

If the weight of the bullet proof vests would make them impractical, then many students would not be able to use the vests.

If the bullet proof vests could not be tracked, them the vests would not last long in the school districts due to theft. Yet note, the tracking of the bullet proof vests is not only to prevent theft, it is also for allowing users of the vest to be tracked in case of a school shooting.

For the foregoing reason there is a need for a method of making and deploying a bullet proof vest that will be inexpensive to fabricate, that will be lightweight, and that will allow users of the vest to be tracked while also preventing theft of the vest.

### SUMMARY

The present invention describes a method of making and deploying a bullet proof vest that will be inexpensive to fabricate, that will be lightweight, and that will allow users of the vest to be tracked while also preventing theft of the vest.

The method comprising initially providing fifteen fiberglass sheets that are 0.030 of an inch in width, providing a fiberglass resin, providing a press that can apply a pressure of at least seventy pounds per square inch to a stack or sheet of material, and providing a vest that has a front and rear pocket, the vest having at least one strap to secure the vest. Then, placing a first sheet of the fiberglass sheets on a flat surface. Next, spreading the fiberglass resin on top of the fiberglass sheet. Then, placing a first subsequent fiberglass sheet directly on top of the fiberglass sheet having the resin spread on top of it. Next, allowing twenty minutes to pass before spreading fiberglass resin on top of the first subsequent fiberglass sheet. Then placing a second subsequent fiberglass sheet directly on top of the fiberglass sheet having the resin spread on top of it. Next, allowing twenty minutes to pass before spreading fiberglass resin on top of the second subsequent fiberglass sheet. Repeating eleven times the steps of spreading the fiberglass resin on the subsequent fiberglass sheet, placing the subsequent fiberglass sheet directly on top of the fiberglass sheet having the resin spread on top of it, and allowing twenty minutes to pass before spreading the fiberglass resin on top of the subsequent fiberglass sheet. Then, placing a fifteenth fiberglass sheet directly on top of the previously stacked and adhered fiberglass sheets and allowing an additional twenty minutes to pass, thereby creating a fiberglass sheet adhered stack. Next, placing the fiberglass sheet adhered stack in the press and pressing the stack for twenty-four hours at a pressure between seventy to eighty pounds per square inch, thereby forming a fiberglass plate. Then shaving any excess fiberglass resin from the fiberglass plate. And lastly, inserting the plate within either pocket of the vest. The method further comprising inserting a second fiberglass plate in the remaining pocket of the vest. The fiberglass resin bonds the fiberglass sheets to each other and the pressing step insures that a strong bond is created between each fiberglass sheet.

Embodiments of the present invention can have hook and loop fastening means and tracking devices planted within the vests.

The bullet proof vests of the present invention are designed to be stowed within or underneath school desks. Ideally, the vests would be secured on the desks so that when the vests are withdrawn from the desks the tracking devices would immediately notify a central processing unit that the bullet proof vests have been deployed for use. Deployment of the vests will alert authorities of an active shooting event or of an attempted theft of the vests.

In case of a shooting, the bullet proof vest of the present inventions would be used as follows: first, the student would detach the vest from the desk in which the bullet proof vest is stowed; then the student would place the vest over his torso; and lastly, the student would secure the vest on his or her torso.

The bullet proof vest of the present invention is designed to stop a 9 mm bullet, a .44 magnum bullet and a twelve gauge shotgun slug. Other calibers of ammunition have not been tested as of the writing of this application.

An object of the present invention is to provide a method of making an inexpensive bullet proof vest.

Another object of the present invention is provide a method of making an inexpensive bullet proof vest that can be deployed in school districts.

Yet another object of the present invention is to provide a method of making an inexpensive bullet proof vest that can be tracked.

Still another object of the present invention is to provide a method of making an inexpensive bullet proof vest that will have a theft deterrent.

Yet still another object of the present invention is to provide a method of making and deploying a bullet proof vest in educational facilities that will reduce casualties in an active shooter situation.

### DRAWINGS

These and other features, aspects, and advantages of the present invention will become better understood with regards to the following description, appended claims, and drawings where:

FIG. 1 is a perspective view of a first side of a bullet proof vest of the present invention;

FIG. 2 is a perspective view of another side of the bullet proof vest; and

FIG. 3 is a flow chart of how the bullet proof vest of the present invention is deployed in an educational setting.

### DESCRIPTION

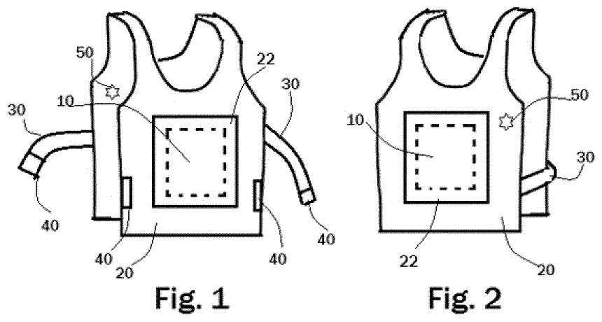

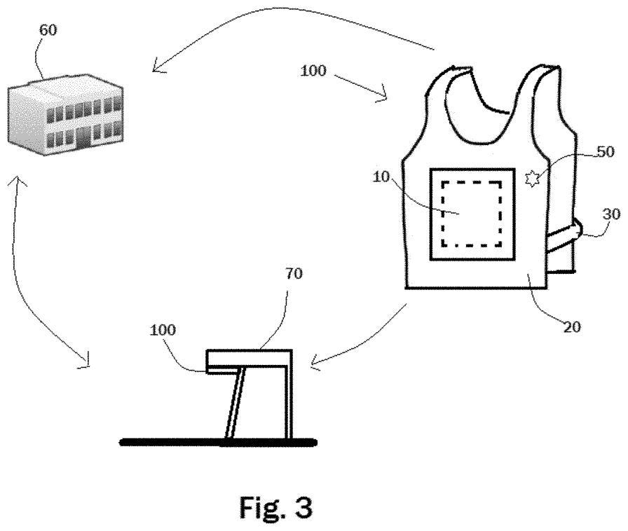

As seen in FIGS. 1-3, the present invention describes a method of making a bullet proof vest 100 and its manner of use. The method comprising providing fiberglass sheets that are 0.030 of an inch in width, providing a fiberglass resin, providing a press that can apply a pressure of at least seventy pounds per square inch to a stack or sheet of material, and providing a vest 20 that has a front 22 and rear pocket 22, the vest having at least one strap 30 to secure the vest 20. Then, placing a sheet of the fiberglass sheet on a flat surface, next, spreading the fiberglass resin on top of the fiberglass sheet. Then, placing a first subsequent fiberglass sheet directly on top of the fiberglass sheet having the resin spread on top of it. Next, allowing twenty minutes to pass before spreading fiberglass resin on top of the first subsequent fiberglass sheet. Then, placing a second subsequent fiberglass sheet directly on top of the fiberglass sheet having the resin spread on top of it. Next, allowing twenty minutes to pass before spreading fiberglass resin on top of the second subsequent fiberglass sheet. Repeating, eleven times, the steps of spreading the fiberglass resin on the subsequent fiberglass sheet, placing the subsequent fiberglass sheet directly on top of the fiberglass sheet having the resin spread on top of it, and allowing twenty minutes to pass before spreading the fiberglass resin on top of the subsequent fiberglass sheet. Then, placing a fifteenth fiberglass sheet directly on top of the previously stacked and adhered fiberglass sheets and allowing an additional twenty minutes to pass, thereby creating a fiberglass sheet adhered stack. Next, placing the fiberglass sheet adhered stack in the press and pressing the stack for twenty-four hours at a pressure of between seventy to eighty pounds per square inch, thereby forming a fiberglass plate 10. Then, shaving any excess fiberglass resin from the fiberglass plate 10. And lastly inserting the fiberglass plate 20 within either pocket 22 of the vest 20. The above method places one fiberglass plate 10 within the vest 20, so the process is repeated to place a second fiberglass plate 10 within the vest 20. In a preferred embodiment of the present invention, the fiberglass sheets measure twelve inches in height and twelve inches in length.

The strap 30 of the present invention may comprise of a hook and loop fastening means 40 that is used to secure the bullet proof vest 100 around the torso of a user.

The method of making a bullet proof vest may also comprise of placing a tracking device 50 in the bullet proof vest 100 to prevent theft of the bullet proof vest 100 and for tracking of the bullet proof vest 100. The tracking device 50 of the bullet proof vest 100 can be connected to a central monitoring system 60 that will alert a monitor of the central monitoring system of when the bullet proof vest 100 is deployed from a stored position.

The bullet proof vest 100 of the present invention, ideally will be stored in or attached to a desk 70 in a school or educational facility. The bullet proof vest 100 may also be used outside of an educational facility and need not be connected to a fixed object.

An advantage of the present invention is that it provides a method of making an inexpensive bullet proof vest.

Another advantage of the present invention is that it provides a method of making a bullet proof vest that can be deployed in school districts.

Yet another advantage of the present invention is that it provides a method of making a bullet proof vest that can be tracked.

Still another advantage of the present invention is that it provides a method of making a bullet proof vest that has a theft deterrent.

Yet still another advantage of the present invention is that it provides a method of making and deploying a bullet proof vest in educational facilities that reduces casualties in active shooter situations.

While the inventor's above description contains many specificities, these should not be construed as limitations on the scope, but rather as an exemplification of several preferred embodiments thereof. Accordingly, the scope should not be determined by the embodiments illustrated, but by the appended claims and their legal equivalents.

What is claimed is:

1. A method of making and deploying a bullet proof vest, comprising:
providing fifteen fiberglass sheets that are 0.030 of an inch in width;
providing fiberglass resin;
providing a press that can apply a pressure of at least seventy pounds per square inch to a stack or sheet of fiberglass material;
providing a vest that has a front and rear pocket, the vest having at least one strap to secure the vest;
placing a first fiberglass sheet of the fiberglass sheets on a flat surface;
spreading the fiberglass resin on top of the first fiberglass sheet;
placing a first subsequent fiberglass sheet directly on top of the first fiberglass sheet having the resin spread on top of it;
allowing twenty minutes to pass before spreading fiberglass resin on top of the first subsequent fiberglass sheet;
placing a second subsequent fiberglass sheet directly on top of the first subsequent fiberglass sheet having the resin spread on top of it;
allowing twenty minutes to pass before spreading fiberglass resin on top of the second subsequent fiberglass sheet;
repeating, eleven times, the steps of spreading the fiberglass resin on the subsequent fiberglass sheet, placing the subsequent fiberglass sheet directly on top of the fiberglass sheet having the resin spread on top of it, and allowing twenty minutes to pass before spreading the fiberglass resin on top of the subsequent fiberglass sheet;
placing a fifteenth fiberglass sheet directly on top of the previously stacked and adhered fiberglass sheets and allowing an additional twenty minutes to pass, thereby creating a fiberglass sheet adhered stack;
placing the fiberglass sheet adhered stack in the press and pressing the stack for twenty-four hours at a pressure between seventy to eighty pounds per square inch, thereby forming a fiberglass plate;
shaving any excess fiberglass resin from the fiberglass plate; and
inserting the fiberglass plate within either pocket of the vest.

2. The method of making and deploying a bullet proof vest of claim 1, wherein the fifteen fiberglass sheets measure twelve inches in length and twelve inches in height.

3. The method of making and deploying a bullet proof vest of claim 1, wherein a second fiberglass plate made using the present method is inserted in the remaining pocket of the vest.

4. The method of making and deploying a bullet proof vest of claim 3, wherein the strap defines a hook and loop fastening system that is used to adjust the bullet proof vest on a user's torso.

5. The method of making and deploying a bullet proof vest of claim 3, comprising placing a tracking device in the bullet proof vest to prevent theft of the bullet proof vest and tracking of any student wearing the bullet proof vest.

6. The method of making and deploying a bullet proof vest of claim 5, wherein the strap defines a hook and loop fastening system that is used to adjust the bullet proof vest on a user's torso.

7. The method of making and deploying a bullet proof vest of claim 6, comprising connecting the tracking device to a central monitoring system.

8. The method of making and deploying a bullet proof vest of claim 7, comprising storing the bullet proof vest within an educational desk after it is connected to the central monitoring system.
